(19) United States
(12) Patent Application Publication
(10) Pub. No.: US 2010/0153144 A1
(43) Pub. Date: Jun. 17, 2010

(54) Automated Check-in for Reserved Service

(75) Inventors: Jared Miller, Humble, TX (US); Michael Dennis Gorman, The Woodlands, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: Continental Airlines, Inc., Houston, TX (US)

(21) Appl. No.: 12/634,459

(22) Filed: Dec. 9, 2009

Related U.S. Application Data
(60) Provisional application No. 61/121,050, filed on Dec. 9, 2008.

(51) Int. Cl. G06Q 50/00; G06Q 10/00; G06F 17/30

(52) U.S. Cl. 705/6; 705/5; 707/E17.014; 707/769

(57) ABSTRACT

Automated check-in systems for air travel and similar services are described herein. A customer indicates a preference for automatic check-in at some point prior to when check-in is permitted. At the first time that check-in is permitted, the automatic check-in data for customers indicating a preference for automatic check-in is processed. The automatic check-in may be prioritized according to various rules.

### CROSS-REFERENCE TO RELATED APPLICATIONS

This is a non-provisional of U.S. Provisional Appl. Ser. No. 61/121,050, filed 9 Dec. 2008, which is incorporated by reference in its entirety and to which priority is claimed.

### BACKGROUND

In many industries, reserving and using a service requires a customer to perform multiple steps. In the airline industry, for example, a passenger typically makes a reservation for a trip well in advance—anywhere from a day or two to even a month or more in advance. Then, on the day of travel, the passenger “checks-in” with the airline. Historically, check-in occurred when the passenger arrived at the airport—hence the name “check-in.” Checking-in informs the airline that the passenger intends to avail himself of his reservation for travel. At the time of check-in, the passenger may receive a boarding pass, which is a printed paper that allows the passenger to board the aircraft.

In many cases, customers with reservations may not avail themselves of the services for which they have made a reservation. Again using the airline industry as an example, a passenger's plans may change, or he may be caught in traffic, stuck in a meeting, etc. To avoid having substantial unused services, many service providers take more reservations than they have capacity to handle. In this way, the service providers can ensure that the full capacity of the service will be used when the no-shows are accounted for. In such situations, customers who fail to check-in by a predetermined time will effectively have their reservation cancelled so that a later reserving customer may have their space. Again, the airline industry's “oversell” is an excellent example of this process.

A passenger's check-in time can also be used for other purposes, such as to determine priority for seat upgrades, etc. Thus, it is desirable for a passenger to check-in as early as possible, but this can impose difficulty on the passenger because of the unused time between arrival at the airport and departure of the flight and/or of the passenger is unable for scheduling reasons to arrive early at the airport.

To address this problem and to provide better services to their customers, many airlines have implemented on-line check-in procedures. This allows a passenger to check-in before arriving at the airport. These systems—most of which are Internet-based—allow the passenger to access the airline website from a personal computer (e.g., a home or office computer) and to check-in for the flight (i.e., informs the airline that he intends to avail himself of his reservation to travel). In turn, the system gives the passenger the option of receiving a boarding pass that can be printed at a local printer, e-mailed, faxed, etc. Additionally, some airlines have begun to experiment with electronic boarding passes, in which a boarding pass is stored on a handheld computer, mobile telephone, personal digital assistant (PDA), or similar device. Alternatively, some systems allow the passenger to check-in remotely and receive a printed boarding pass when the passenger arrives at the airport.

These on-line check-in systems have proven extremely popular. In fact, a majority of the passengers of the Assignee of this application used online check-in on the outbound leg of their trips. However, use of such systems has been substantially lower on return legs. Various reasons for this include a lack of access to the Internet, lack of a printer, etc.

One solution to this problem would be to allow a passenger to check-in for the return leg of the trip at the same time as the outbound leg. However, present airline security regulations in the U.S. as administered by the Transportation Security Administration (TSA) do not permit a passenger to check-in more than 24 hours before a flight. Therefore, what is needed in the art is a technique for facilitating automated online check-in for a passenger in a manner that complies with relevant security regulations and also allows for airline business rules regarding such matters as seat assignments, upgrades, etc. to be implemented.

### SUMMARY

An airline's reservation system stores flight reservations for passengers. At some point prior to a leg of a reserved flight, a passenger enters check-in information, and the airline's reservation system obtains an automatic check-in indication, if available, for the passenger. The check-in information and the automatic check-in indication are then stored for later retrieval. The reservation system subsequently monitors for a check-in time prior to the departure time of the flight in which to perform automatic check-in. Once this check-in time is reached, the reservation system automatically checks-in the passenger for the flight leg using the stored check-in information. A boarding pass is generated for the flight leg and can be issued to the passenger using e-mail, fax, electronic download, or other delivery method.

In addition to check-in, the system can handle reservations for other types of services, including seat assignments, upgrades, meals or drinks, baggage allowance, entertainment choices, comfort items (e.g., pillows, blankets, etc.), access to a travel lounge, etc., and the system can be used for reservations for services from hotels, automobiles, trains, and other industries. Either way, the system obtains two different reservations for users. Both reservations include a service that has a specific service time but has limited availability. However, the service is not selectable (available, enabled, etc.) when the reservations are obtained for the users. Instead, the system obtains automatic selection indications from one set of users (i.e., first users with first reservations) and not other users (i.e., second users with second reservations).

The system stores all of this information and monitors for a time prior to the specific service time when the service is selectable. When the monitored time is reached, the system automatically sorts the first reservations having automatic selection indications based on at least one priority rule. Then, the system confirms the first reservations for the first users. Once this is done, the second reservations for second users who do not have automatic selection indications are handled separately as they come, and second confirmations of the service are generated for the these users, if the service is still available.

The foregoing summary is not intended to summarize each potential embodiment or every aspect of the present disclosure.

### BRIEF DESCRIPTION OF THE DRAWINGS

FIG. 1 depicts a process for allowing automatic check-in on a return leg of a trip.

FIG. 2 depicts a process for allowing automatic check-in on any leg (or all legs) of a trip.

FIGS. 3A-3B are block diagrams of a computer system for implementing various automatic check-in techniques.

FIG. 4 depicts a web page in which a user can make certain selections for automatic check-in according to the present disclosure.

### DETAILED DESCRIPTION

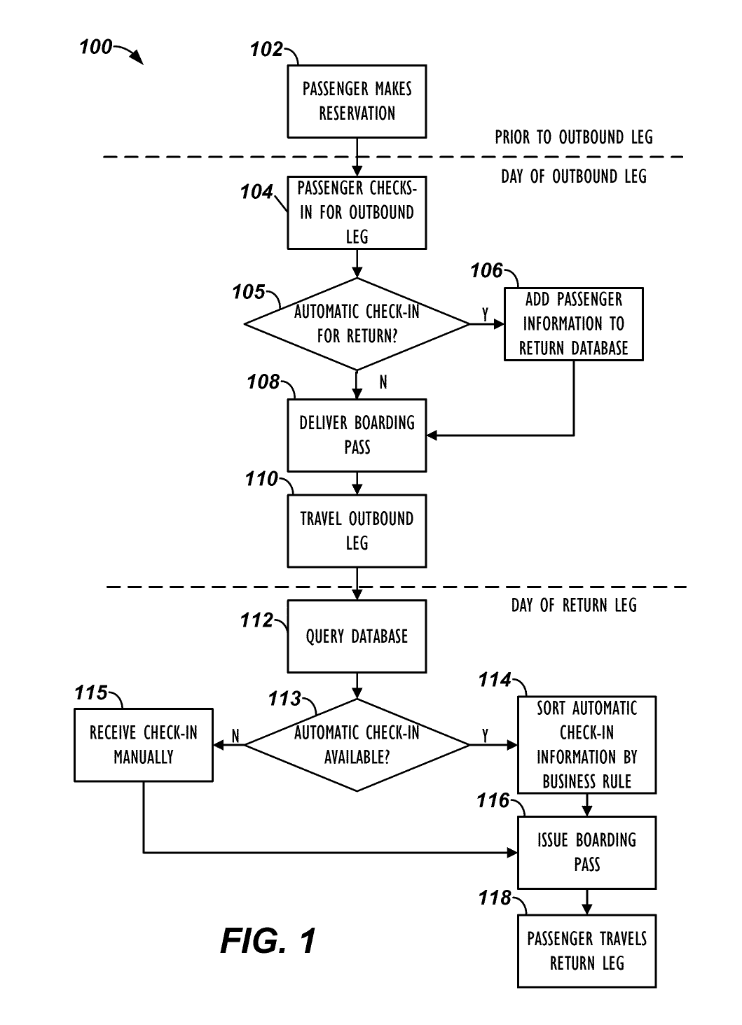

FIG. 1 illustrates a flowchart of the airline perspective of a round-trip travel process 100 including automated check-in for a return leg. The process is initiated when the passenger makes a reservation (Block 102). As described in greater detail below, this may include online purchase, telephone purchase, purchase at a ticket agent, etc. In general, this will occur prior to the date on which travel is reserved, but this is not necessarily the case.

On the day of the outbound leg (or within 24 hours of the outbound departure) the passenger will check-in for the outbound leg (Block 104). This check-in could be in person at the airport either at the ticket counter or an automated kiosk. This check-in could also be a remote check-in via the Internet, a telephone system, etc. Additionally, the time period need not be on the same day of travel or within 24 hours and could change depending on TSA regulations, airline business requirements, etc. In any case, at check-in, the passenger may be given the option of automated check-in for one or more additional legs of their trip, if available. In general, the additional leg can be a return flight or a remaining segment if the passenger's travel is not a simple round trip.

If the passenger indicates negatively when queried about automatic check-in, a boarding pass for the outbound leg is generated and issued to the passenger (Block 108), and the passenger can then travel the outbound leg (Block 110). For this passenger, check-in for any additional leg (e.g., return leg) may need to be performed manually using any of the available methods. However, should this passenger wish to indicate automatic check-in at a later time before the actual departure date of the return leg, the passenger can select automatic check-in using the techniques disclosed herein so that an automatic boarding pass can be generated and issued when check-in becomes available.

If the passenger indicates a desire to automatically check-in for the one or more additional legs (e.g., return or additional leg with the same or different carrier), however, the passenger information is added to a database corresponding to the flight information, which can include a flight number, date, time, etc. (Block 106). A boarding pass for the outbound leg is generated and issued to the passenger (Block 108), and the passenger can then travel the outbound leg (Block 110).

At a subsequent point-in-time (e.g., on the day of the return leg or a further leg if not a simple round trip), the database is queried for automatic check-in information (Block 112). Again, the exact timing of this step can vary based on airline business policies, TSA security regulations, and the like. If automatic check-in information is available, the associated check-in information can be sorted by various airline business rules to determine in which order to generate boarding passes and for which passengers (Block 114). These rules may be configured to give priority for certain passengers, flights, reservations, and the like, and the priority can be based on any of a number of variables, including, for example, a date when the flight reservation was initially made, a date when the flight reservation was purchased, a class of fare for the flight reservation, a frequent flyer status of the passenger, or an indication of priority for the reservation, the flight, or the passenger.

The automatic check-in information may then be processed, preferably at the earliest time for which check-in is available, according to the sorted priority. Boarding passes are then generated and issued to these passengers who are automatically checking-in (Block 116). When issuing these boarding passes, they may be delivered by any of a variety of methods, including airport pick-up either from a ticket agent or kiosk, e-mail, fax, download to handheld device, physical delivery, mail, etc. Having the issued boarding pass, the passenger can then travel the return leg (Block 118).

Some passengers who do not have automatic check-in may still check-in using a ticket counter clerk, internet check-in, kiosk, or the like. For these passengers, the reservation system will obtain manual check-in information (Block 115), and the system may generate and issue boarding passes for the passengers, although they are not given priority (Block 116). These passengers can then travel the return leg, if issued a boarding pass for the flight (Block 118).

As evidenced above, the automatic check-in is a form of check-in that is free or independent of user interaction, especially by a passenger, at the time when check-in for a flight becomes available. Therefore, the passenger does not need to access an airline's reservation system to check-in for a return leg of a flight reservation or other additional leg. Instead, the airline's system automatically performs this function at the appropriate time and issues the boarding pass to the passenger by a delivery method that the passenger selects.

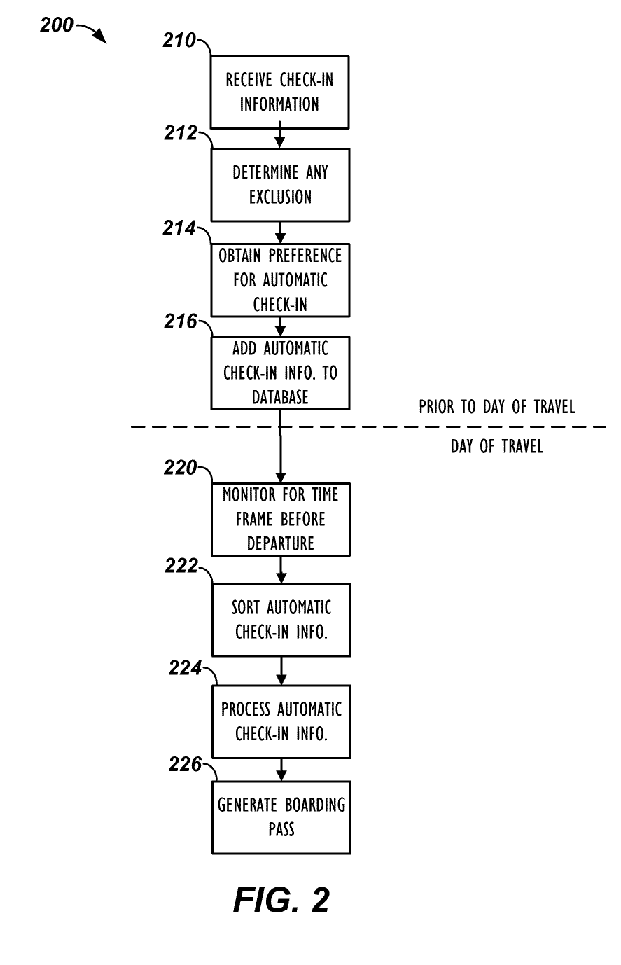

In another embodiment illustrated in FIG. 2, a passenger may automatically check-in for one or all legs of a flight. In this case, the passenger provides check-in information (e.g., confirmation number for the reservation, number of bags to be checked, etc.), which the airline's reservation system receives via the Internet, automated kiosk, phone system, etc. (Block 210). Before proceeding, the airline's reservation system determines whether the passenger is ineligible for automatic check-in based on one or more exclusions (Block 212).

In general, most passengers will be presented with an option for automatic check-in. However, some passengers may be excluded from automatic check-in for various reasons, and the system at Block 212 can determine those passengers, reservations, or flight legs that may be ineligible. For example, some passengers may have further documentation requirements for which automatic check-in is not suitable, or some passengers may have special seating assignments or specific needs that would preclude automatic check-in. As one particular example, non-U.S. citizens travelling to the U.S. may need to have documents inspected before checking-in. Additionally, unaccompanied minors may not be given access to automatic check in. Likewise, passengers with reservations for an exit row may have to confirm that they are not travelling with small children and are physically able to operate the emergency exits so these passengers may not be given automatic check-in as an option. These and other situations may exclude a passenger from automatic check-in.

If the passenger has an indication of ineligibility for automatic check-in (Block 212), then the airline's reservation system will bypass the automatic check-in steps that follow. If an exclusion does not apply, however, an indication for automatic check-in of the passenger can be obtained (Block 214). When and how the indication is obtained may vary depending on the implementation. For example, the passenger may indicate a desire to check-in automatically for legs of a flight at the time the reservation is made or at some other time prior to the flight. Querying the passenger about automatic check-in in these circumstances can use a selectable option suitable for an interface used by the passenger to interact with the airline's reservation system. For example, the selectable option can be part of a web page if the passenger is using a computer and the Internet to interface with the airline's reservation system. When selecting automatic check-in, the passenger may also be able to choose how to receive the automatically generated boarding pass or passes. As detailed herein, for example, the passenger may be able to select to receive the boarding pass via e-mail, fax, or mobile device, or the passenger can request that the boarding pass be ready for printing at an airport kiosk.

As an alternative to querying the passenger directly, indirect querying can be used. For example, the passenger may be a member of the airline's frequent flyer program and may have a profile that indicates a preference to be checked-in automatically for flights whenever that option is available. This profile may already be stored before the passenger's reservation is made, and the airline's reservation system can automatically indicate automatic check-in for the frequent flyer passenger based on that stored preference.

Regardless of how the indication is obtained, the passenger's automatic check-in information is added to an automatic check-in database for later retrieval (Block 216). As the day and time of the passenger's flight approaches, the airline's system monitors for a given point-in-time or time frame prior to the departure time in which to check-in the passenger automatically (Block 220). As noted above, check-in for a passenger of an airline flight may be allowed only within a permitted time period or window (i.e., 24 hours) before the flight's departure time. Check-in at any time prior to that permitted time period may be restricted. For the current system, the given point-in-time monitored by the airline's system may vary depending on the implementation, but it can generally be on the day of the flight or within whatever applicable period (preferably the first time at which check-in for the flight is available).

Because the automatic check-in is associated with one or more legs of a flight, the reservation system is preferably capable of handling various changes that may occur, such as changed departure times, a substituted or changed flight for the passenger, etc. As noted previously, the automatic check-in indication is associated or logged with details of the passenger's reservation, such as flight numbers, departure times, etc. Should the departure time of the associated flight change, then the reservation system can also change the time when automatic check-in occurs. Likewise, if the passenger has reserved a flight and has made an automatic check-in indication, should the passenger go back at another time and change the flight, then the automatic check-in indication can be tracked to the new flight. In essence, the automatic check-in indication can follow or track with the passenger, especially if the indication is linked to a profile for the passenger.

When automatic check-in is available, the check-in information is sorted according to whatever rules the airline desires to implement (Block 222). Then, the check-in information is processed in the order determined by the sort (Block 224), and boarding passes are generated and issued by any of the techniques described above (Block 226). These passengers without automatic check-in would have their manual check-ins handled and boarding passes issued in a conventional manner without priority.

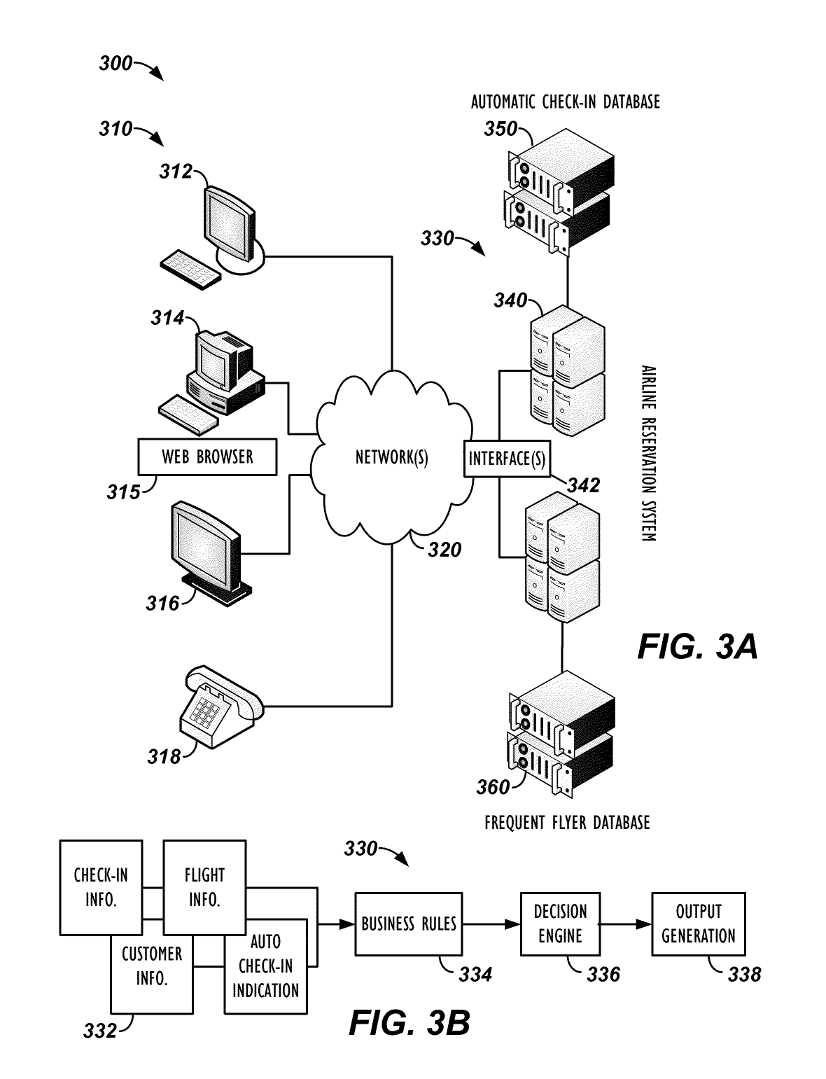

FIGS. 3A-3B show block diagrams of a computer system 300 for implementing the automatic check-in techniques described above. Each element of the system 300 may represent a computer (i.e., a server, a special-purpose computer, a general-purpose computer with appropriate software programming, or a functional module within a general-purpose computer or server). Additionally, the various functional modules could be distributed across a number of computers. For their part, the computers will each include at least a processor, memory, and input and output devices and may include network interfaces, user interfaces, and printer interfaces.

Additionally, the methods described herein may be implemented using a program storage device having program instructions stored thereon for causing a programmable control device to perform the automated passenger flight check-in methods. Accordingly, the methods described herein may be implemented using general-purpose computers and appropriate software, which may be stored on a computer readable medium, including, for example, optical disks, magnetic disks or tapes, solid-state memory devices (ROM or RAM), etc.

As shown in FIG. 3A, a user (i.e., passenger, ticket agent, etc.) can interact with an airline reservation system 330 via one or more types of terminal 310 and network 320. The terminal 310 can include a remote terminal 312, a personal computer 314, an automated kiosk 316, a telephone 318, a personal digital assistant (not shown), or other device. Likewise, the networks 320 can include the Internet, an intranet, a telephone network, or a network suited to the particular terminal 310.

For example, a passenger can interact with a ticket counter clerk, who may use the remote terminal 312 connected to the airline reservation system 330 via an appropriate network 320. Alternatively, the passenger can directly use a personal computer 314, an automated airport kiosk 316, a telephone 318 (either mobile or landline), or a personal digital assistant (not shown) to interact directly with the airline reservation system 330 via one or more applicable networks 320. In some embodiments, the terminal 310, such as the personal computer 314 or automated kiosk 316, may include an Internet web browser 315 or may include a special-purpose program for interacting with the airline reservation system 330. If the terminal 310 is a telephone 318, the airline reservation system 330 can use an interactive voice response (IVR) system (examples of which are known in the art) or a touch-tone dialing system (examples of which are also well known) to interact automatically with the passenger over the telephone 318 and appropriate network 320.

Using the terminal 310 and network 320, the user interacts with the airline reservation system 330. As shown, the airline reservation system 330 may include one or more computers (e.g., servers) 340 and one or more appropriate network interfaces 342. For example, the one or more servers 340 can include a web server or any another mechanism for interaction, such as IVR or touch-tone dialing as described above.

For its part, the airline reservation system 330 interacts with an automatic check-in database 350 as described previously. In general, a user will indicate a preference for automatic check-in at some point in time, which preference will be indicated in the automatic check-in database 350. This user preference can be provided when purchasing the ticket (e.g., using the user terminal 310) or when signing up for a frequent flyer program. In the event a frequent flyer profile is used, the airline reservation system 330 may also interact with a frequent flyer database 360 in addition to the automatic check-in database 350. The databases 350/360 can be stored on one or more suitable storage devices, such as a database server or the like.

As shown in FIG. 3B, the reservation system 330 has various data sources 332 that can include customer, flight, check-in, automatic check-in, and other information. These sources 332 can be incorporated into one or more databases. A decision engine 336 uses business rules 370 and make decisions about the information in the sources. For example, the rules 370 can be used to sort the automatic check-in information based on priorities described above. From the decision (such as performing automatic check-in for passengers before a flight's departure time), the decision engine 336 leverages an output generation component 338, which generates the desired output (such as an e-mail, download, fax, etc. of a boarding pass, confirmation, or the like).

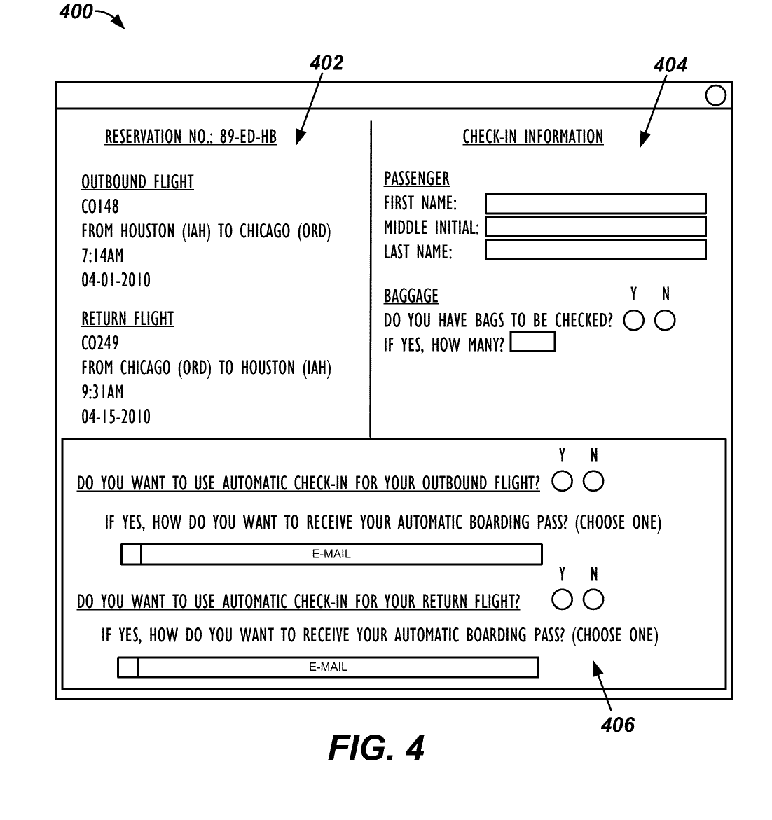

FIG. 4 depicts an example web page 400 in which a user can make certain selections for automatic check-in according to the present disclosure. This web page 400 may appear on the passenger's personal computer while making a reservation. As shown, the web page 400 indicates reservation information 402 including, for example, a reservation number and details for outbound and return legs for a round trip flight that the passenger has already selected. As also shown, the web page 400 has inputs 404 for check-in information, which can include name of the passenger, baggage details, and other information typically used but not shown.

In addition to this conventional information, the web page 400 includes selections 406 for the passenger to choose automatic check-in for the outbound and/or return legs for the reservation. Also, the passenger can select a delivery method for receiving the boarding pass for each automatic check-in selected. As noted previously, the delivery methods can use e-mail, fax, or mobile device, or the passenger can request that the boarding pass be ready for printing at an airport kiosk. Although positive selections 406 are shown, the system may assumptively enroll the passenger in automatic check-in if eligible, in which case the passenger may have to opt out of this selection on the web page 400.

The web page 400 is merely illustrative and can include more or less information. Moreover, more than one web page may be used to obtain this and other desired information from the passenger. Additionally, the details of the web page 400 can be suited for any particular user interface for the particular type of terminal (See 310; FIG. 3) used to interact with the airline's reservation system.

The foregoing description of preferred and other embodiments is not intended to limit or restrict the scope or applicability of the inventive concepts conceived of by the Applicants. For example, the techniques and devices have been described in the context of airline reservations and check-in procedures. As noted throughout, passengers cannot typically check-in for a flight until some time period (typically 24 hours) before the flight's departure time. There may be other reservable services besides check-in where passengers may be unable to make a selection, chose an option, opt for a preference, etc. until some particular time before the departure of a flight.

For example, when reserving a flight, the passenger may not be able to select another service, such as a particular seat assignment, at the time the reservation is made. Instead, the ability to pick a particular seat may not become available until sometime after the reservation has been made and/or not until sometime before the departure time of the flight. Therefore, the techniques and devices disclosed herein can be applied to these types of service (such as picking a seat assignment) to automatically sort and enable (select, enroll, choose, etc.) the service for the passenger when it becomes available. In this way, when making an reservation or checking-in for a flight, the passenger can indicate an automatic selection for the service. In this way, the service can be initiated automatically once available, and a confirmation can be automatically generated for the passenger.

Besides seat assignments, the techniques and devices disclosed herein can be applied to other services, including, but not limited to, upgrades, meals or drinks, baggage allowance, in-flight entertainment choices, comfort items (e.g., pillows, blankets, etc.), access to the airline's lounge in the airport, and any other service offered by the airline. Additionally, the techniques and devices described in the context of airline travel herein may be equally applicable to reservations for services from other travel industries, including hotel reservations, automobile reservations, train reservations, etc.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An automated passenger check-in method, comprising:
storing a travel reservation for a passenger in memory associated with a computer, the travel reservation including at least one leg with a departure time, wherein check-in by the passenger for the at least one leg is restricted at least until a check-in time prior to the departure time;
storing check-in information for the passenger in the memory, the check-in information including an automatic check-in indication for the at least one leg;
monitoring with the computer for the check-in time;
automatically checking-in the passenger for the at least one leg with the computer using the stored check-in information in response to the monitored check-in time; and
generating a boarding pass for the at least one leg with the computer.

2. The method of claim 1, wherein automatically checking-in the passenger comprises sorting the stored check-in information for the passenger with other check-in information stored for other passengers based on one or more priority rules.

3. The method of claim 2, wherein one or more of the other passengers have automatic check-in indications.

4. The method of claim 2, wherein the one or more priority rules include one or more of: a date when the travel reservation was initially made, a date when the travel reservation was purchased, a class of fare for the travel reservation, a frequent travel status of the passenger, an indication of priority for the travel reservation, an indication of priority for the at least one leg, or an indication of priority for the passenger.

5. The method of claim 1, further comprising initially obtaining the automatic check-in indication for the at least one leg.

6. The method of claim 5, wherein initially obtaining the automatic check-in indication comprises obtaining a delivery selection for the boarding pass and storing the delivery selection in the memory.

7. The method of claim 6, wherein the delivery selection comprises one or more of: manual delivery, passenger pick-up, e-mail, fax, or electronic download.

8. The method of claim 6, wherein generating the boarding pass comprising issuing the boarding pass based on the stored delivery selection.

9. The method of claim 5, wherein initially obtaining the automatic check-in indication comprises querying the passenger to select automatic check-in.

10. The method of claim 9, wherein the automatic check-in indication is obtained when the travel reservation is created.

11. The method of claim 9, wherein the automatic check-in indication is obtained when the passenger checks-in for another leg of the travel reservation.

12. The method of claim 5, wherein initially obtaining the automatic check-in indication comprises querying a profile for the passenger stored in the memory associated with the computer, the profile indicative of a preference for automatic check-in.

13. The method of claim 5, wherein initially obtaining the automatic check-in indication comprises determining ineligibility for automatic check-in based on one or more exclusions.

14. The method of claim 13, wherein the one or more exclusions include one or more of: the passenger requiring documentation, the passenger being an unaccompanied minor, the passenger having a reserved seat on an exit row, a departure for the leg being within a short time frame, an indication of ineligibility for the travel reservation, an indication of ineligibility for the leg, or an indication of ineligibility for the passenger.

15. The method of claim 1, further comprising monitoring for a change in the departure time for the at least one leg and modifying the check-in time based on the changed departure time.

16. The method of claim 1, wherein the check-in time is 24 hours or sooner before the departure time for the at least on leg.

17. A program storage device having program instructions stored thereon for causing a programmable control device to perform an automated passenger travel check-in method according to claim 1.

18. An automated service method, comprising:
obtaining with a computer first reservations for first users, the first reservations including a service having a service time and having limited availability, the service not being selectable when the first reservations are obtained;
obtaining with the computer second reservations for second users, the second reservations including the service, the service not being selectable when the second reservations are obtained;
obtaining with the computer automatic indications for the first users and not for the second user, the automatic indications indicating automatic selection of the service for the first users;
storing the first and second reservations and the automatic indications in memory associated with the computer;
monitoring with the computer for a time prior to the service time when the service becomes selectable;
automatically sorting the first reservations with the computer in response to the monitored time, the automatic sorting being based on at least one priority rule; and
confirming the first reservations with the computer based on the automatic sorting;
handling the second reservations separately with the computer as long as the limited availability of the service permits; and
confirming with the computer the second reservations that meet the limited availability.

19. An automated passenger flight check-in method, comprising:
storing a flight reservation for a passenger in memory associated with a computer, the flight reservation having a first leg with a first departure and having a second leg with a second departure;
obtaining check-in information for the passenger with the computer prior to the first departure;
obtaining an automatic check-in indication with the computer prior to the first departure;
storing the check-in information and the automatic check-in indication in the memory;
checking-in the passenger for the first leg with the computer at a first time before the first departure using the stored check-in information;
generating a first boarding pass for the first leg with the computer;
automatically checking-in the passenger for the second leg with the computer at a second time, the automatic check-in being based on the automatic check-in indication and using the stored check-in information, the second time being prior to the second departure for the second leg; and
generating a second boarding pass for the second leg with the computer.

20. A computer system for facilitating automatic check-in of passengers, the computer system comprising:
memory having at least one database storing travel reservations and check-in information for passengers, each of the travel reservations including at least one leg with a departure time, the check-in information for each of the passengers including an automatic check-in indication for the at least one leg; and
one or more computers operatively coupled to the memory and operative to:
monitor for points-in-time prior to the departure times when check-in for the at least one leg is available,
automatically check-in the passengers at the monitored point-in-times based on the stored check-in information and the automatic check-in indications, and
generate boarding passes for the at least one legs based on the automatic check-ins.

21. The computer system of claim 20, further comprising one or more network interfaces communicatively coupling the one or more computers to one or more networks, the one or more computers receiving the check-in information via the one or more network interfaces and storing the check-in information in the memory.

22. The computer system of claim 21, wherein the one or more network interfaces receive the check-in information from one or more remote clients.

23. The computer system of claim 21, wherein the one or more networks are selected from the group consisting of a telephone network, the Internet, or an intranet.

24. The computer system of claim 21, further comprising one or more terminals communicatively coupled to the one or more computers via one or more networks, the one or more terminals obtaining the check-in information for travel reservations and querying the passengers to indicate automatic check-in, the one or more terminals communicating the check-in information and the indication to the one or more computers for storage in the memory.

25. The computer system of claim 24, wherein the one or more terminals comprises a ticket counter terminal or an automated kiosk.
